(19) United States
(12) Patent Application Publication
(10) Pub. No.: US 2015/0306447 A1
(43) Pub. Date: Oct. 29, 2015

(54) MOUNTABLE BAND CONNECTOR FITNESS DEVICE

(71) Applicant: Matthew Joseph Neal-Buhler, Surrey (CA)

(72) Inventor: Matthew Joseph Neal-Buhler, Surrey (CA)

(21) Appl. No.: 14/697,290

(22) Filed: Apr. 27, 2015

Related U.S. Application Data
(60) Provisional application No. 61/984,712, filed on Apr. 25, 2014.

(51) Int. Cl. A63B 21/16; F16M 13/02

(52) U.S. Cl. CPC A63B 21/16; F16M 13/022

(57) ABSTRACT

An apparatus for anchoring an exercise band comprises a base panel having front and rear surfaces extending between first and second ends, wherein said rear surface is securable to an object. The apparatus further includes an arcuate panel extending from said second end to a free distal end with an intermediate portion therebetween and a slot formed through said arcuate panel sized to receive an exercise band therethrough. The arcuate panel curves away from said base panel to said front surface of said base panel.

### CROSS REFERENCE TO RELATED APPLICATION

This application is claims priority from U.S. Provisional Patent Application No. 61/984,712 filed Apr. 25, 2014 entitled Mountable Band Connector Fitness Device.

### BACKGROUND OF THE INVENTION

1. Field of Invention

This invention pertains to the field of fitness products in general and in particular to an apparatus for anchoring an exercise band to an object.

2. Description of Related Art

Fitness products utilizing resistance bands may present certain advantages over some other exercise devices, such as convenient portability, negative resistance, increased degree of resistance, and the capability of improving a person's range of motion. The convenient portability owes itself to the fact that resistance bands are relatively thin and not bulky, lightweight, that one band or set of bands may be used for multiple exercises and workouts, and that even a small resistance band can create a significant amount of resistance useful for a particular exercise. The resistance is created by the elastic properties of the bands.

Resistance can be increased or decreased according to band material, length, and for some types of bands or how tight the bands are wrapped. Some bands having a certain amount of resistance may be better off for certain types of exercises. Also, a variety of exercises may be performed using resistance bands, such as muscle building, calorie burning, and/or for physiotherapy, and different muscle groups may be targeted. Exercises incorporating resistance bands may also present certain advantages over some other types of exercises that do not incorporate resistance bands since resistance bands may allow constant/negative resistance, increased resistance in the same exercise, and a greater range of motion.

Despite their well-known benefits, several problems are at times also encountered with the use resistance bands. In particular, one difficulty when using resistance bands is determining where to attach the bands in order to obtain the desired or full range of motion. Although some of the same muscle groups may be targeted using resistance bands as using free weights and certain machines, to accomplish this, it is crucial that the resistance band be positioned appropriately. For example, for bicep curls or overhead presses, the band may be stretched from a vertically low, horizontally centered position. For lat pulldowns or triceps pushdowns exercises, a vertically high, horizontally centered position might be desirable. For chest exercises or shoulder rotations, a vertically centered, horizontally offset position of the bands might be appropriate. One difficulty encountered when attempting to position the exercise band is finding an object to which it may be attached having the desired vertical and horizontal orientation, and being able to easily adjust the location of the resistance band(s) according to particular resistance band exercise.

Previous attempts have been made to attach resistance bands to objects such as for example, a door or door jamb such as between the door frame or the door jamb. However, where resistance bands are tied to an object, such tying and tying can be burdensome (for example, when changing the position of the bands in order to perform other exercises.). Similarly many previous attempts to utilizing resistance bands may not allow attaching to an object in a sufficiently convenient and prompt manner.

### SUMMARY OF THE INVENTION

Described herein is an exercise band connecting device mountable to an anchor, which allows an exercise band to connect quickly and easily to a device. Device embodiments may be used with a variety of exercise bands and may have particular application for an exercise band of the sort having two ends, with at least one end that may be made wider than the width of the band length (such as those bands colloquially known as “therapy” bands). For example, one end of a particular sort of exercise band may be tied in a knot, the knot being wider than the band length. One feature of the device for connecting such a band may be an exercise band connecting portion having a slit, a portion of the slit being wider than the width of the band length yet narrower than the width of one of the ends. Stated differently, a knotted or wider end may slip over the slit portion, and the band length may be placed into the opening of the slit, and slid down to the desired position. Thus the wider band end may be placed on the side of the slit opposite from the direction the band is stretched, allowing the band length to pass through the slit and stretch therethrough, but not allowing band end to pass therethrough, and holding the band in a relatively stable position connected to the device. Thus the slit allows for a band to be attached and removed easily and quickly to and from the device.

Moreover, the portion of the device having the slit may comprise a front end that is arcuate (or radially curved), with the slit running along the longitudinal axis of the arc and with the arc facing in the direction in which the band is stretched. In one embodiment, the band may pass through the portion of the slit that substantially faces most closely the point towards which the band is being stretched. Thus, the radial design and the slit may be only allow a substantially full range of motions, but may also assist in preventing kinks in the band between a band's point of connection (the slit) when being stretched and the opposite end of the band where the force is being applied that causes the band to stretch. Also, certain slit embodiments may allow more than one band to fit at the same time in the slit, but at different portions thereof.

Embodiments of the device may also comprise an anchor mounting portion having a design in accordance with the particular type of anchor to which it is desired that the device mount. For example, in one embodiment intended to be conveniently portable, the anchor mounting portion may have a design for mounting to an unhinged side of a door. Such an anchor mounting portion, in one embodiment, may comprise a clamp for mounting to the door in such a manner that the door may be shut while in a mounted position. One variation or such a clamp may comprise two clamp sides that each may apply pressure on opposite door sides, which pressure may be accomplished by one or both clamp sides being angled inward toward one another, with the clamp sides being comprised of rigid material (such as, for example, 16-gauge steel). Such clamp side of rigid material, in one embodiment, may also be coated with certain nonabrasive material (such as certain types of plastic or powder coating) so that the pressure applied on the door does not damage the door, or with friction creating material to prevent the clamp from sliding in position along the door. Some such embodiments may comprise dimensions for fitting doors up to two inches thick, which doors may be often found in residential areas.

Other anchor mounting portion embodiments may comprise designs intended for mounting in a fixed position to an object. For example, certain such embodiments may have holes through which screws may be used to secure the anchor mounting portion to a wall, or more particularly to a stud in a wall. In certain embodiments described and shown herein, the anchor mounting portion may be somewhat parallel with the orientation of the band connecting portion comprising the slit.

Some embodiments may also incorporate features other than the slit for attaching an exercise band (or bands). For example, in one embodiment, the anchor mounting portion and the band connecting portion comprising a slit may be connected by a second band connecting portion that may not comprise a slit. In one embodiment, such a second band connecting portion may be comprised of features for holding an exercise band without an end wider than its band length, or by holding the band at a point that is not the band end (such as, potentially, a tube band). For example, one such embodiment may be comprised of portion having band-holding notches or knobs on opposite sides around, under, or against which separate areas of the band length may be placed. Thus separate areas of the band length may be held against the knobs and two ends of the band may be stretched equally and oppositely. Alternatively, two separate bands each having an end wider than the bands' lengths may be each held in place by the band holding features of the second band connecting portion, and for certain applications, may pass through the slit.

The capability to easily place and remove exercise bands in the slit or around the band holding features may save a user time and effort for purposes of performing exercises for fitness or therapy purposes. The capability of mounting the device to a variety of anchors may be beneficial for users seeking to position the device so that bands are oriented properly in order to perform a certain exercise or to target certain muscle groups. Moreover, the capability of removably mounting the device (for such applicable embodiments), for example, to an unhinged side of a door, also may be beneficial for performing a variety of exercises requiring different positioning of the band(s), and may also be found beneficial for persons traveling who might otherwise experience greater inconvenience carrying a different and likely larger exercise system less capable of allowing performance of a variety of exercises.

In one embodiment the radially curved part of the band connecting portion having a slit may be comprised a rigid material having a certain level of elasticity that allows the material to bend under a certain amount of force, and then return to the former position when the force is no longer applied. Thus, in addition to the resistance caused by the elasticity of the band, the bendable part may also add to the resistance. Thus, embodiments of the invention may allow a user to experience greater resistance than would otherwise be experienced if using the bands alone. In addition, in certain embodiments the radially curved part may bend prior to the band being stretched to its maximum point of elasticity, then once the radially curved bends a certain amount, the band may then be stretched to its maximum point of elasticity. In this manner, a greater spectrum of resistance may be experienced for a longer time. In addition, it is possible that the bending of the radially curved part prior to the band reaches its maximum point of elasticity may assist to prevent inadvertent snapping of the band.

According to a first embodiment of the present invention there is disclosed an apparatus for anchoring an exercise band comprising a base panel having front and rear surfaces extending between first and second ends, wherein the rear surface is securable to an object. The apparatus further includes an arcuate panel extending from the second end to a free distal end with an intermediate portion therebetween and a slot formed through the arcuate panel sized to receive an exercise band therethrough. The arcuate panel curves away from the base panel to the front surface of the base panel.

The slot may extend into the free distal end of the arcuate panel. The slot may extend into the intermediate portion of the arcuate panel so as to maintain a connected portion proximate to the free distal end. The slot may have a width selected to receive an exercise band therein. The slot may have a width between 5/16 and ½ inches. The slot may have a widened portion proximate to the distal end of the arcuate panel.

The distal end may be oriented back towards the base panel. The arcuate panel may be continuous with the base panel. The base panel may include at least one fastener bore therethrough.

The apparatus may further comprise a bridging panel extending substantially perpendicularly from the base panel in an opposite direction from the arcuate panel and a rear panel extending from the bridging panel such that the bridging panel is located between the base panel and the rear panel. The rear panel may be biased towards the base panel. The bridging panel may have a length selected to permit the base panel and the rear panel to grip a door therebetween.

The base panel, bridging panel and rear panel may be co-formed of a continuous material. At least one of said base panel and arcuate panel may include hooks thereinto.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention wherein similar characters of reference denote corresponding parts in each view,

FIG. 1 is a front-side perspective of an apparatus for securing an exercise band to an object according to a first embodiment of the present invention.

FIG. 2 is a front-side perspective of an apparatus for securing an exercise band to an object according to a further embodiment of the present invention.

FIG. 3 is a front-side perspective of an apparatus for securing an exercise band to an object according to a further embodiment of the present invention.

FIG. 4 is a side perspective view of the apparatus of FIG. 3 secured over a door with exercise bands secured thereto.

FIG. 5 is a side view of the apparatus of FIG. 3 secured over a door.

FIG. 6 is a front view of the apparatus of FIG. 3.

FIG. 7 is a plan view of a cut sheet for forming the apparatus of FIG. 3.

### DETAILED DESCRIPTION

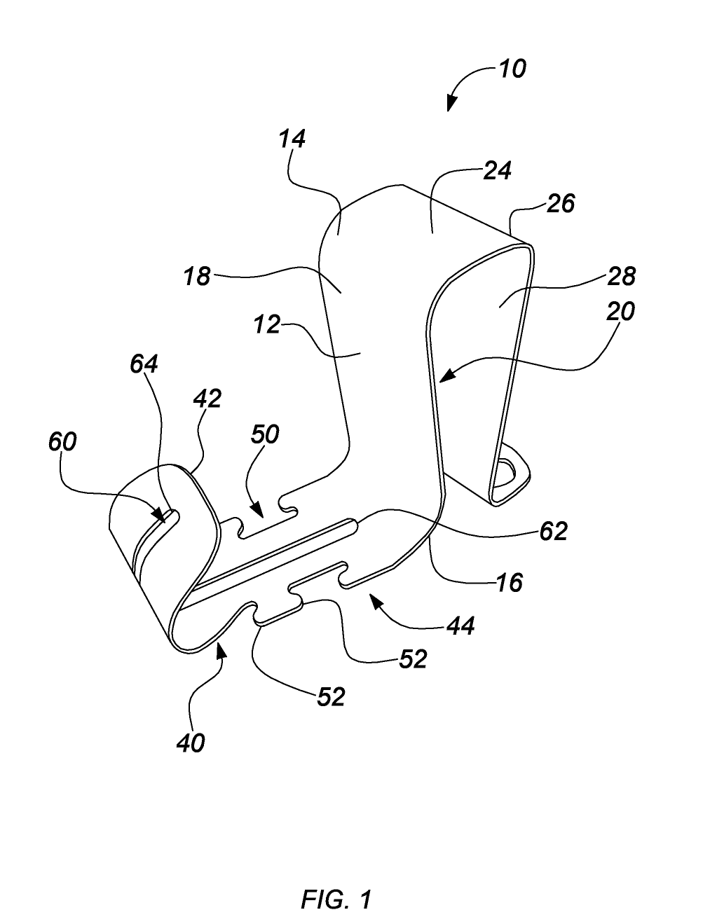

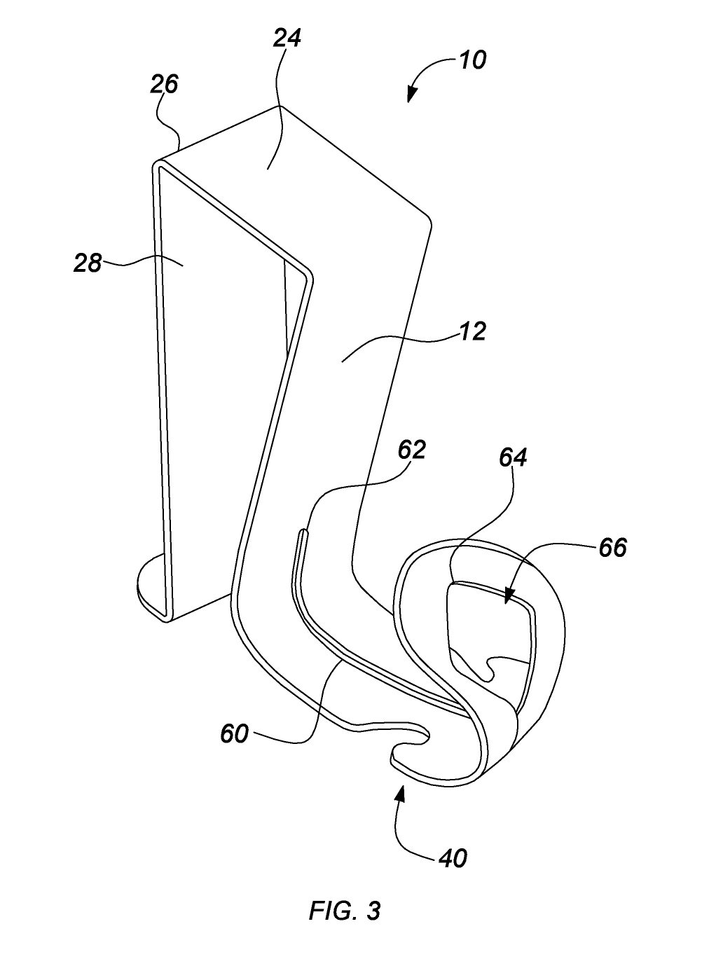

Referring to FIG. 1, an apparatus for providing an anchoring base for an exercise band is illustrated generally at 10. “Anchor” is defined herein as object to which either at least one resistance band may be attached or to which an exercise device utilizing at least one resistance band may be mounted. The apparatus 10 comprises a base panel 12 having an arcuate panel 40 extending therefrom having a slot or slit 60. As shown in FIG. 3, the slot 60 may be used to connect a first exercise band 8 as are commonly known in the art thereto. As are commonly known the exercise band 8 may be of any known shape such as planar or tubular. The base panel 12 comprises a substantially planar member having a front and a rear surface, 18 and 20, respectively extending between first and second ends, 14 and 16, respectively.

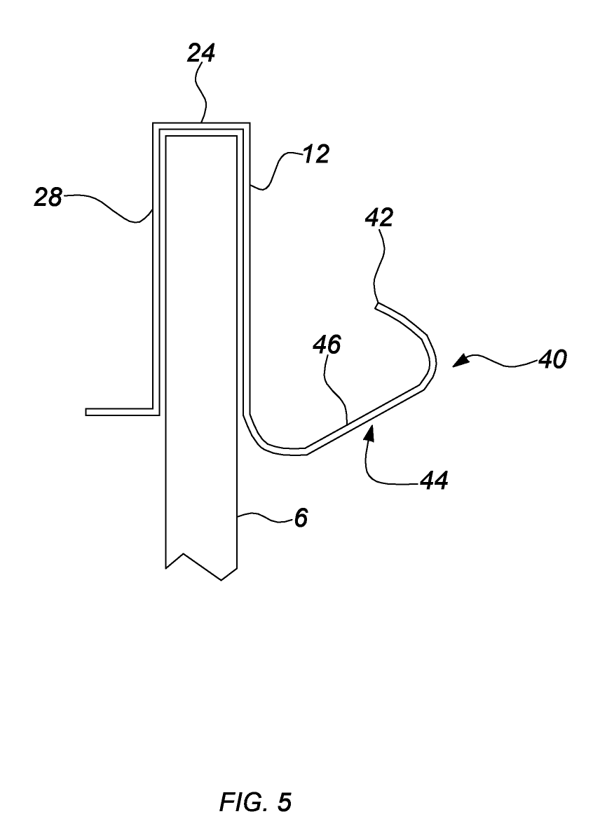

As illustrated in FIG. 1, the arcuate panel 40 extends from the second end 16 of the base panel 12 and curves away from the front surface 18 thereof to a free distal end 42 with an intermediate portion 44 located therebetween. As illustrated in FIG. 5, the arcuate panel 40 may include a substantially planar portion 46 intermediate. Optionally, the arcuate panel 40 may be continuously curved with a constant or variable curvature. As illustrated in FIG. 5, optionally, the free distal end 42 of the arcuate panel may be oriented so as to be angled back towards the front surface 18 of the base panel. The arcuate panel 40 may be formed continuously with the base panel, such as by cutting and bending a sheet of material as will be further described below. The arcuate panel may vary in shape and degree of curvature (or lack thereof), thickness, and may be comprised of varying materials, according to desired use (for example according to the intended angle at which a band may be pulled and according to desired bending of the arcuate panel.

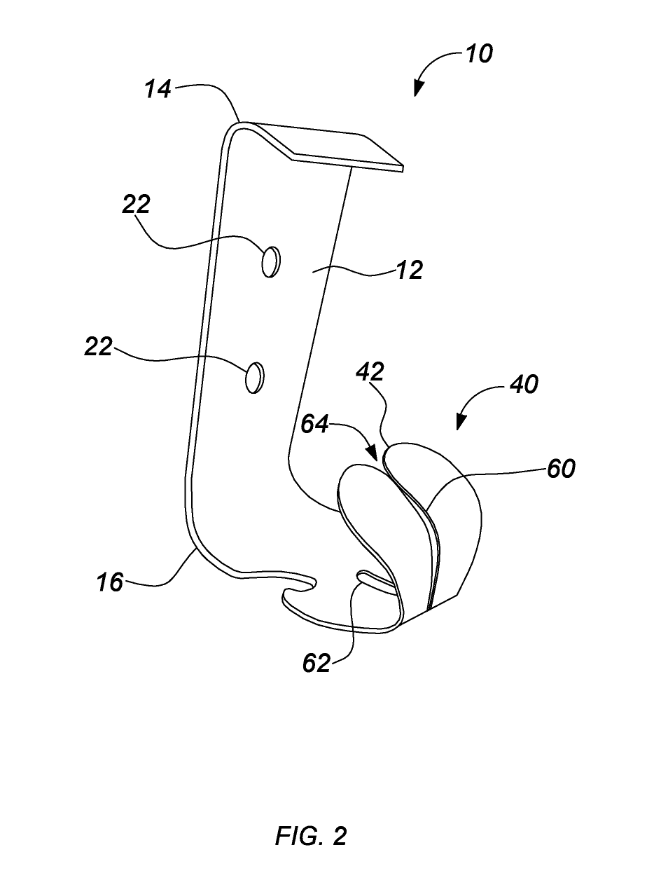

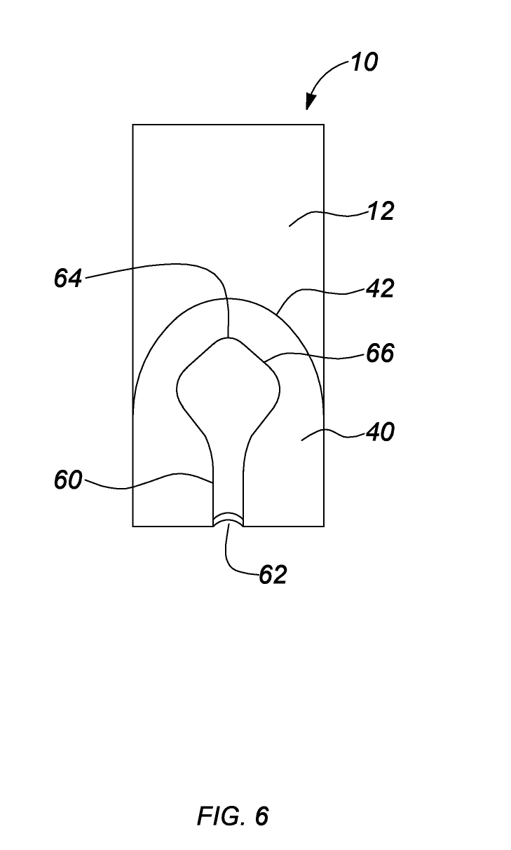

The slot or slit 60 is cut into or otherwise formed longitudinally through the arcuate panel 40 so as to provide a location into which the exercise band 8 may be passed and thereafter secured thereto. The slot 60 extends between first and second ends, 62 and 64, respectively and has a width selected to permit an exercise band 8 to be passed therethrough while preventing a knot in an exercise band from passing therethrough. In particular, the slot may have a width selected to be between 5/16 and ½ inches (8 and 13 mm) wide by way of non-limiting example. Additionally, it will be appreciated that the slot may have an initial width proximate to the second end 64 wider than a width proximate to the first end 62. As illustrated in FIGS. 1 and 3, the slot 60 may be closed so as to not extend to the distal end 42 of the arcuate panel 40. Optionally as illustrated in FIG. 2, the slot 60 may extend to the free distal end 42 so as to be open on the second end 64 for the introduction of the exercise band thereinto. Furthermore, optionally as illustrated in FIG. 3, the second end 64 may include a widened portion 66 sized to permit a knot in an exercise band to pass therethrough for the introduction of the knot thereinto. The widened portion 66 may be of any suitable shape, such as by way of non-limiting example, a diamond shaped cavity as illustrated in FIG. 6, although other shapes may be useful as well. The widened portion 66 has a width, such as approximately 1¼ inches (32 mm) by way of non-limiting example. It will be appreciated that the widened portion permits an exercise band to connect to the apparatus 10 by placing a portion thereof in the slot 60 so that when the exercise band would be stretched in a direction away from the apparatus without the knot fitting through the slot 60.

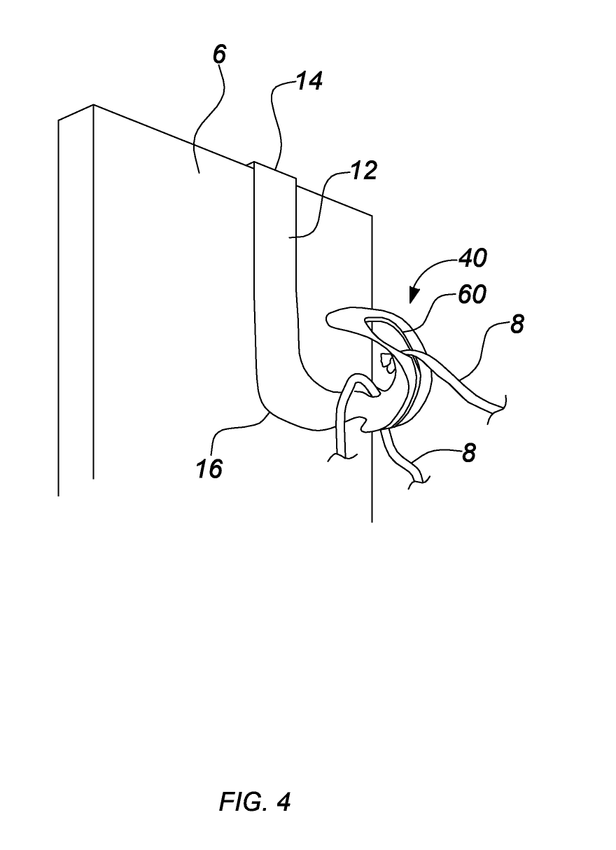

As illustrated in FIG. 2, the base panel 12 may include at least one fastener bore 22 extending therethrough for securing the base panel 12 to a wall or a stud thereof through the use of screws or bolts (not shown). Optionally, as illustrated in FIGS. 1 and 3, the base panel may include a bridging panel 24 extending away from the rear surface 20 at the first end 14 of the base panel. In such embodiments, the apparatus 10 may also include a rear panel 28 extending from a distal end 26 of the bridging panel 24 in the same direction as the base panel 12 so as to form a void 30 therebetween. It will be observed that the void may be sized to receive the edge of a door 6 therein as illustrated in FIGS. 4 and 5 such as by sizing the bridging panel 24 to have a length between the base and rear panels of approximately 1⅜ inches (35 mm). Furthermore, the rear panel and base panel may be biased towards each other so as to clamp onto both sides of an unhinged side of a door 6. In particular, such clamping may be facilitated in one embodiment by one or both of the base or rear panels being angled inward toward the other.

As shown in FIGS. 1-3, apparatus 10 may include side notches 50 forming hooks 52 for engaging the exercise bands 8 and securing such exercise bands thereto. The hooks 52 may be oriented towards or away from the free distal end 42 of the arcuate portion 40 as desired by a user. It will be appreciated that different embodiments may vary, and some embodiments may feature different dimensions and designs of notches, slots, base panels, and/or arcuate panels.

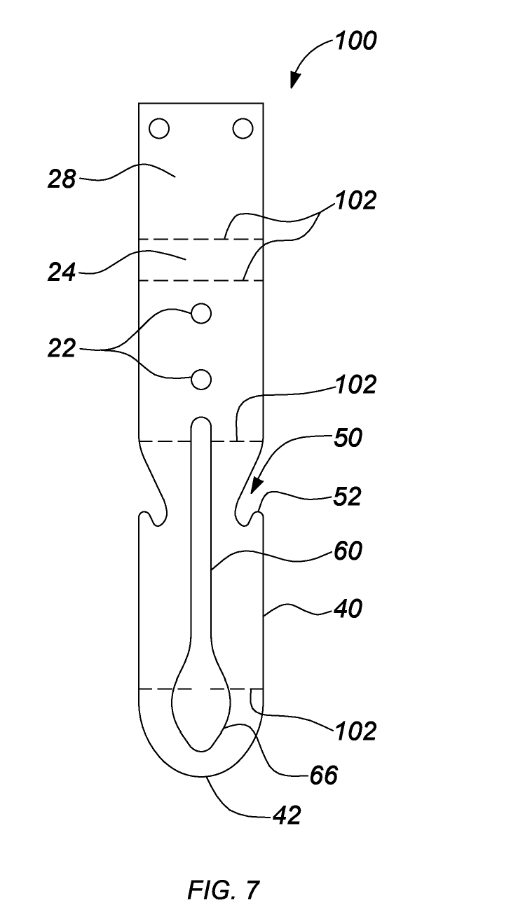

Turning now to FIG. 7, a cut sheet 100 for forming the apparatus 10 is illustrated. The cut sheet 100 may be formed or cut using any known method, such as plasma cutting, shears or the like. The cut sheet may be formed of any suitably strong material, such as, by way of non-limiting example, metals, plastics and composite materials. Thereafter, the cut sheet may be bent or otherwise deformed along bend lines 102 so as to be formed into the apparatus illustrated in FIG. 3. It will be appreciated that although the cut sheet 100 illustrated in FIG. 7 corresponds to the embodiment illustrated in FIG. 3, similar cut sheets may similarly be formed for other variations of the apparatus as well.

While specific embodiments of the invention have been described and illustrated, such embodiments should be considered illustrative of the invention only and not as limiting the invention as construed in accordance with the accompanying claims.

What is claimed is:

1. An apparatus for anchoring an exercise band comprising:
a base panel having front and rear surfaces extending between first and second ends, wherein said rear surface is securable to an object;
an arcuate panel extending from said second end to a free distal end with an intermediate portion therebetween, said arcuate panel curving away from said base panel to said front surface of said base panel; and
a slot formed through said arcuate panel sized to receive an exercise band therethrough.

2. The apparatus of claim 1 wherein said slot extends into said free distal end of said arcuate panel.

3. The apparatus of claim 1 wherein said slot extends into said intermediate portion of said arcuate panel so as to maintain a connected portion proximate to said free distal end.

4. The apparatus of claim 1 wherein said slot has a width selected to receive an exercise band therein.

5. The apparatus of claim 4 wherein said slot has a width between 5/16 and ½ inches.

6. The apparatus of claim 4 wherein said slot has a widened portion proximate to said distal end of said arcuate panel.

7. The apparatus of claim 6 wherein said distal end is oriented back towards said base panel.

8. The apparatus of claim 1 wherein said arcuate panel is continuous with said base panel.

9. The apparatus of claim 1 wherein said base panel includes at least one fastener bore therethrough.

10. The apparatus of claim 1 further comprising a bridging panel extending substantially perpendicularly from said base panel in an opposite direction from said arcuate panel and a rear panel extending from said bridging panel such that said bridging panel is located between said base panel and said rear panel.

11. The apparatus of claim 10 wherein said rear panel is biased towards said base panel.

12. The apparatus of claim 10 wherein said bridging panel has a length selected to permit said base panel and said rear panel to grip a door therebetween.

13. The apparatus of claim 10 wherein said base panel, bridging panel and rear panel are co-formed of a continuous material.

14. The apparatus of claim 1 wherein at least one of said base panel and said arcuate panel includes hooks thereinto.
